(19) United States
(12) Patent Application Publication
(10) Pub. No.: US 2022/0050056 A1
(43) Pub. Date: Feb. 17, 2022

(54) IN-SITU MECHANICAL PROPERTY DETERMINATION USING SMART OPTICAL MONITORING DURING ADDITIVE MANUFACTURING

(71) Applicant: Sensigma LLC, Ann Arbor, MI (US)

(72) Inventors: Joohyun Choi, West Bloomfield, MI (US); Jyoti Mazumder, Ann Arbor, MI (US)

(73) Assignee: Sensigma LLC, Ann Arbor, MI (US)

(21) Appl. No.: 17/086,041

(22) Filed: Oct. 30, 2020

Related U.S. Application Data
(60) Provisional application No. 62/929,125, filed on Nov. 1, 2019.

(51) Int. Cl. G01N 21/71; B22F 12/41; B33Y 40/00; B23K 26/03

(52) U.S. Cl. CPC G01N 21/718; B22F 12/41; B23K 2103/10; B23K 26/032; B33Y 40/00

(57) ABSTRACT

Mechanical properties of materials fabricated with additive manufacturing process are determined through optical monitoring in real time. A plasma generated in a zone where a laser interacts with deposited material is monitored using optical emission spectroscopy to generate one or more plasma spectral lines. The emission lines are analyzed to determine the hardness, micro-hardness, yield/residual stress, tensile strength, or other mechanical characteristics of the material. The composition may be an alloy such as an aluminum-magnesium alloy, including 7000 series aluminum alloys. The mechanical property may be derived from a change in a ratio of the plasma spectral lines, including a change in a ratio of ionic and neutral magnesium (Mg) associated with a 7000 series aluminum alloy. The apparatus and methods are extendable to other alloys and compositions.

### REFERENCE TO RELATED APPLICATIONS

This application claims priority to, and the benefit of, U.S. Provisional Patent Application Ser. No. 62/929,12, filed Nov. 1, 2019, the entire content of which is incorporated herein by reference.

### Field of the Invention

This invention relates generally to additive manufacturing and, in particular, to the determination of mechanical material properties in conjunction with smart optical monitoring.

### BACKGROUND OF THE INVENTION

Our previously described Smart Optical Monitoring System (SOMS), uses optical emission spectroscopy and signal processing to improve manufacturing quality and increase no-defect product throughput in metal manufacturing processes, especially laser/arc/electron-beam welding and additive manufacturing (AM) processes. In SOMS, an optical collimator collects the plasma plume emission from a processing zone, and sends the signal to a spectrometer for signal processing (FIG. 1). The spectrometer has a tunable optical attenuator to adjust the signal intensity to avoid saturation.

The plasma spectra obtained from the spectrometer are analyzed in a signal processing unit to determine how different defects, composition and phase transformation affect the plasma characterization. During analysis, a refined signal processing algorithm is used to detect and categorize different defects, analyze composition and phase transformation and predict the cause of these changes (FIG. 2).

It has been shown that SOMS has the ability to perform in-situ characterization of defects such as porosity, composition, and phase transformation in conjunction with fabrication processes by analyzing the radiation emitted by the melt pool with no physical contact. See U.S. Pat. Nos. 8,164,022; 8,723,078; 9,752,988; and 9,981,341, the entire content of each reference being incorporated herein by reference.

Spectroscopic sensors exhibit remarkable immunity to both electromagnetic interference and background acoustic noises associated with fabrication processes. As such, atomic level information unraveling, including mechanical and chemical conditions of the product, should be available using SOMS. As such, an important area of innovation needing attention is in-situ determination of mechanical properties from the optical spectra obtained using SOMS.

### SUMMARY OF THE INVENTION

This invention improves upon existing additive manufacturing processes by providing a no-contact determination of mechanical material properties in conjunction with smart optical monitoring. In an additive manufacturing process wherein a laser beam is used to heat a material to form a melt pool that solidifies to form a desired composition, and wherein a plasma is generated in a zone where the laser interacts with the material the improvement comprises monitoring the plasma, in situ, using optical emission spectroscopy to generate one or more plasma spectral (i.e., emission) lines. The plasma spectral lines are then analyzed to determine a mechanical property of the composition.

The mechanical property of the composition may be hardness, micro-hardness, yield/residual stress, tensile strength, or other characteristics of the material. The composition may be an alloy such as an aluminum-magnesium alloy, including 7000 series aluminum alloys.

In accordance with preferred embodiments, the mechanical property is derived from a change in a ratio of the plasma spectral lines. For example, the mechanical property may be derived from a change in a ratio of ionic and neutral spectral lines. As a further example, when the composition is a 7000 series aluminum alloy, the mechanical property may be derived from a change in a ratio of ionic and neutral magnesium (Mg). In all embodiments, the mechanical property is determined in real time.

### BRIEF DESCRIPTION OF THE DRAWINGS

FIG. 1 illustrates the components of a Smart Optical Monitoring System (SOMS);

FIG. 2 depicts the use of SOMS for additive manufacturing (AM) processes;

FIG. 3 is a plot that shows the ratio of Ionic Mg(II) @280.27 nm/Neutral Mg(I) @285.20 nm (1^{st} layer);

FIG. 4 is a plot that shows the ratio of Ionic Mg(II) @280.27 nm/Neutral Mg(I) @285.20 nm (3^{rd} layer);

FIG. 5 is a plot that shows the ratio of Mg(II) @280.27 nm/Mg(I) @285.20 nm (with no powder, AA7075 substrate);

FIG. 6 is a graph that illustrates Micro-Hardness and Electron Temperature vs. Intensity Ratio (Mg(II)/Mg(I));

FIG. 7(a) is a graph that shows Vickers hardness versus yield stress relationship drawn from the data of Flynn [17-18]; and

FIG. 7(b) is a graph that illustrates Tensile strength versus Vickers hardness for 7010 plate and forging [17].

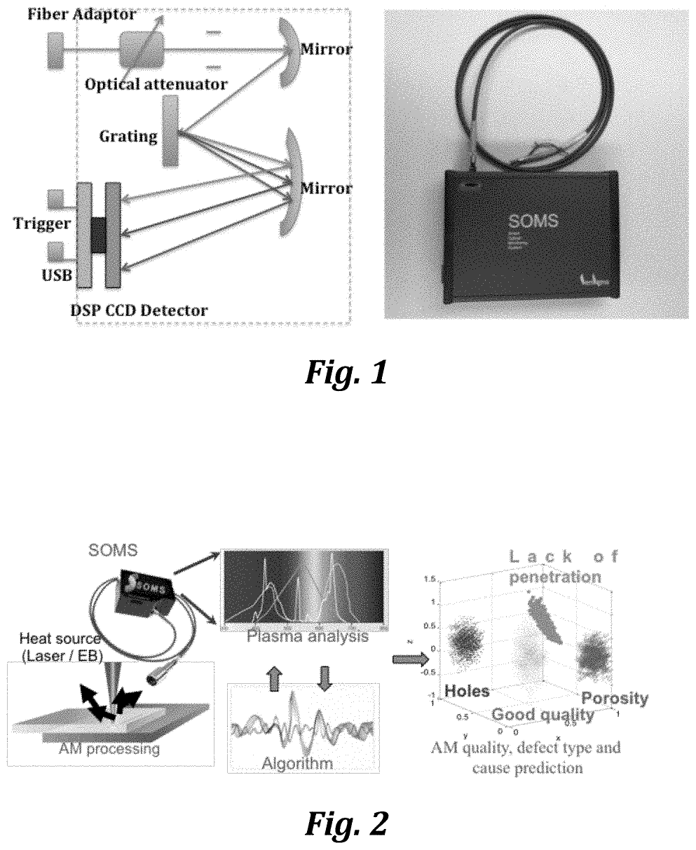

### DETAILED DESCRIPTION OF THE INVENTION

A smart sensor has been developed in conjunction with this invention that provides in-situ and reliable prediction of the components of 7000 series aluminum alloys, including composition, phase transformation, and manufacturing defects in accordance with industrial standards. Features were implemented for automatic defect detection and robust composition detection. For composition analysis, methods to improving the accuracy of the composition measurements have also been identified and investigated.

Furthermore, monitoring the emission lines ratio of ionic and neutral Mg, and the changes in the values of the emission line ratio, a difference in the hardness of the target material, thereby the change of strength of material can be estimated. By fine-tuning the emission lines ratio, thermal residual stress may be estimated to achieve mitigating effects.

### Mechanical Properties: Relationship Between Intensity Ratio and Micro-Hardness

It has been empirically demonstrated that hardness and strength of material (e.g. UTS) have a linear relationship. Hardness is not really an intrinsic property of a material. Rather, the hardness value depends more on the technique and attributes of the material (e.g. strain hardening, microstructure) than on fundamental physical properties. However, measurements were made and reported that there is a correlation between the ionic to atomic spectral lines emission ratios and the surface hardness of solid steel targets. In 2006, Tsuyuki [2] published a paper showing a correlation between concrete compressive strength and shock speed, and that there is a positive relation of shock speed to the rate of ionization of ablated atoms. Establishing a link between intensity ratio of calcium emission lines and concrete strength, they deduced that a material hardness might be indicated by the analysis of laser-induced plasmas.

More recently, application papers [3-5] reported that a line-to-continuum ratio method was used to determine the plasma excitation temperature, T_{e′}, and this also resulted in a linear relationship with the Vickers hardness number of the bio-12 ceramic material. The study showed that the neutral Mg(I) 278.30 nm and the ionic Mg(II) 279.55 nm emission lines were rated, and as indicated that changes in the values of the emission line ratio can be interpreted as a difference in the hardness of the target material.

Detecting another ionic Mg(II), @280.27 nm instead of Mg(II) @279.55 nm, a spectrometer with extended bandwidth, including UV range near 280 nm was employed. Although many elements are effective indicators, the ionic Mg(II) 280.270 nm to neutral Mg(I) 285.215 nm line pair is one of the most widely used [6-8]. This pair serves as an excellent indicator, as the two lines are relatively close to one another and can be acquired in the same spectral window for high-resolution monochromators. Additionally, the lines are very intense, and effective use requires only a small amount of Mg be present in the laser induced plasma. It only requires that Mg be present in the samples, or artificially added as a trace element. It is also important that there are no spectral interferences between the trace element and the other matrix elements.

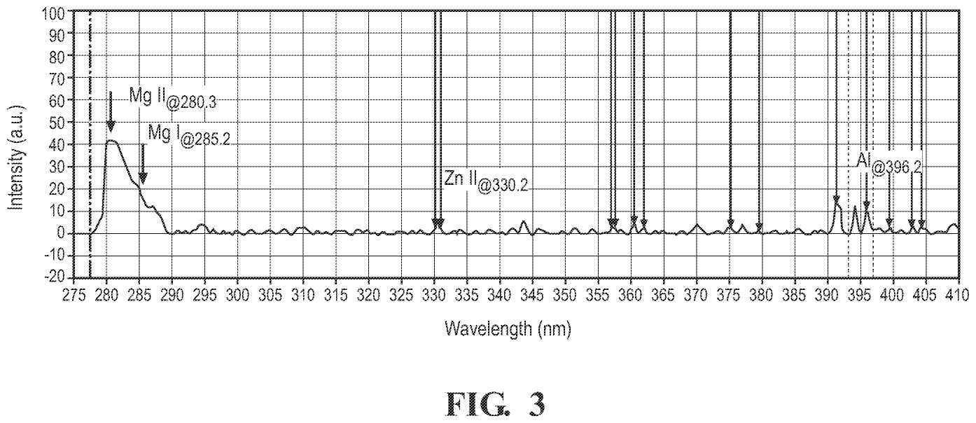

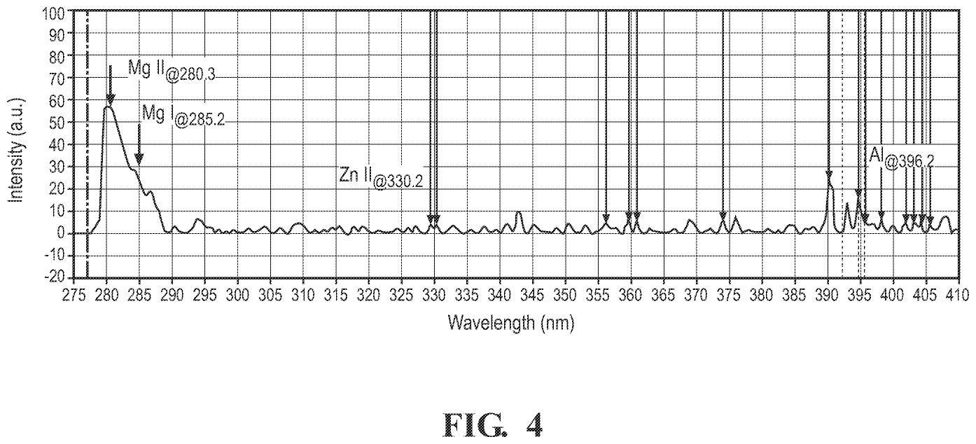

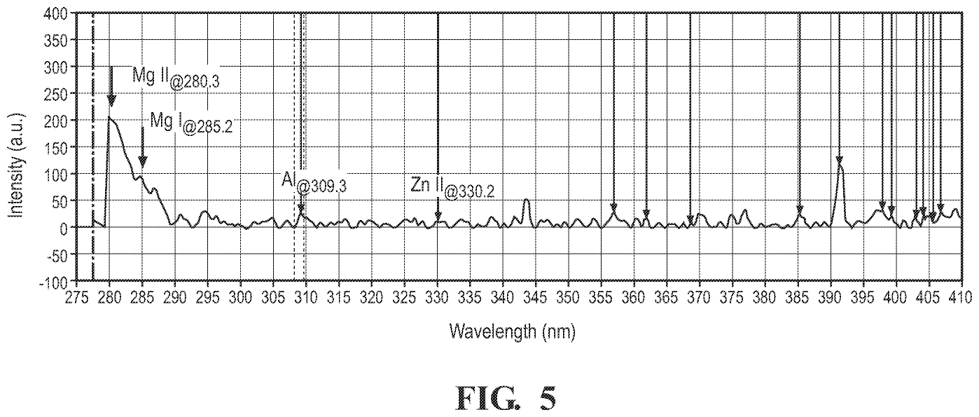

As shown in FIGS. 3-4, the Mg(II) @280.27 nm and the Mg(I) @285.2 nm emission lines (instead of Mg(I) @278.30 nm) were rated, and it was observed that the value of the emission line ratio at the 1^{st} layer is larger than that of 3^{rd} layer, 2.5 to 2.3. The ratio was decreased to ˜10%. FIG. 5 shows the ratio between Mg(II) @280.27 nm and Mg(I) @285.20 nm on the substrate (AA7075) only, i.e., 2.1. If the changes in the values of the emission line ratio can be interpreted as a difference in the hardness of the target material, this invention recognizes that there is likewise a change in the strength of the material.

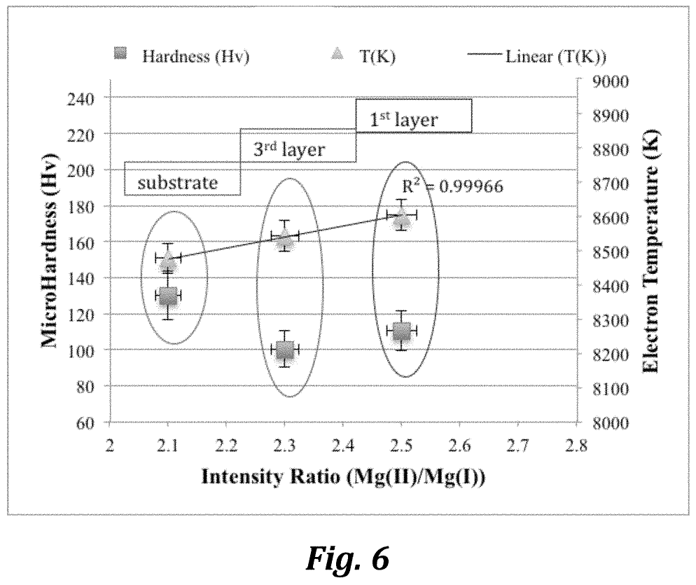

Similar research by a group of researchers reported that the strength in the clad region was decreased due to the loss of Mg and Zn in the application of laser repair of damaged AA7075 components [9-10]. This is not uncommon for Zn, as it has a low vaporization point (906° C.) and has vaporized during laser processing. Mg also has a relatively low vaporization point (1119° C.) and hence a small amount has been lost. The trend implies that high loss of Mg causes low micro-hardness, thereby, higher ratio between Mg(II) @280.27 nm and Mg(I) @285.20 nm as shown in FIG. 6.

Zn(I) @330.2 nm was also detected, but it is noted that the spectral intensity observed was weaker than Mg(I) and Mg(II) as shown in the above FIGS. 3 and 4. This is attributable that the higher atomic energy level (32501.99 & 62772.0 cm⁻¹) to release Zn(I) @330.2 nm is needed than that to release Mg(I) @280.27 nm (0 & 35051.26 cm⁻¹) and Mg(II) @285.2 nm (0 & 35669.31 cm⁻¹) and laser AM is operated in relatively low laser energy density settings, comparing to other laser material processing.

Using the Saha-Eggert equation, which relates the ratio (Iᵢₒₙ/Iₐₜₒₘ) of the two emission lines to the plasma ionization temperature (Tᵢₒₙ) (assuming local thermodynamic equilibrium, LTE) [11-12],

$$\frac{{I}_{i o n}}{{I}_{atom}} = \frac{4.83 \times 1 {0}^{15}}{{N}_{e}} {( \frac{g A}{λ} )}_{i o n} {( \frac{λ}{g A} )}_{atom} \times {T}_{i o n}^{3 / 2} exp [ \frac{- ( {V}^{+} + {E}_{i o n} - {E}_{atom} - Δ {V}^{+} )}{k {T}_{i o n}} ]$$

where all terms have their usual meanings, a potential way to relate the hardness value to the plasma ionization temperature could be established. For the above ratios, plasma ionization temperature was calculated as 8603° K. for Mg(II)@280.27 nm at the 1^{st} layer (FIGS. 3) and 8542° K. at the 3^{rd} layer (FIG. 4).

Recently [14], temporal electron temperature was reported during laser-induced magnesium plasma of Laser Induced Breakdown Spectroscopy (LIBS) with different laser energies and several time delays and at laser energies of 100, 200 and 300 mJ at a delay time of 100 ns, the electron temperatures of Mg(I) were found to be 8810, 9303 and 9724 K, respectively. It is believed that the plasma ionization temperature (8603° K.) of Mg(II)@280.27 nm was calculated a bit lower than those by LIBS due to the laser processing condition (CW vs. pulsed). Table 1, below, presents emission-line data for Saha-Eggert's electron number density calculations [13-14].

TABLE 1
Emission-line data for Saha-Eggert's electron number density calculations

| Species | 1 (nm, 10⁻⁷ cm) | E (cm⁻¹) | g | A (×10⁸ s⁻¹) | ${( \frac{gA}{λ} )}_{atom} / {( \frac{gA}{λ} )}_{ion}$ |
|---|---|---|---|---|---|
| Mg (I) | 285.213 | 35087 | 3 | 5.0 | |
| Mg (II) | 279.553 | 35732 | 4 | 2.6 | 1.4137 |
| Mg (II) | 280.270 | 35652 | 2 | 2.6 | 2.8346 |

Note that k=Boltzmann's Constant (8.6173303×10⁻⁵ eV K⁻¹), Nₑ˜2×10¹⁶ cm⁻¹, 1=wavelength (cm), g=statistical weight of the emitting and ground level, E=energy level (eV), A=transition probability for spontaneous emission, V⁺=ionization potential of the lower ionization stage, ΔV+=a correction to the ionization potential V⁺ of the lower ionization stage due to plasma interactions. It is further noted that for Mg(II) @1=280.27 nm, g=2, A=2.6×10⁸ s⁻¹, Eᵢₒₙ=4.4223 eV (35669.31 cm⁻¹), V⁺=15.035 eV (121267.64 cm⁻¹), for Mg(I) @1=285.2 nm, g=3, A=5.0×10⁸ s⁻¹, Eₐₜₒₘ=4.3457 eV (35051.26 cm⁻¹), V⁺=7.6462 eV (61671.05 cm⁻¹). V⁺ represents the ionization potential of the lower ionization stage; all other symbols have their usual meaning. There is a small correction to the final term, −ΔV⁺, which is a correction to the ionization potential V⁺ of the lower ionization stage due to plasma interactions [12]. ΔV⁺ is usually considered to be negligible for z=1, but for higher ionization states should be taken into account, and may be determined from the following references [11-12]:

ΔV⁺=+ze²/4πε₀ρ_{D}

where z is the ionization charge state, e the electron charge, ε₀ the permittivity of free space and ρ_{D} the Debye shielding distance. Considering a typical laser-induced plasma of T˜7000 K and Nₑ˜2×10¹⁸ m⁻¹, then it yields ρ_{D} as approximately 2.96×10⁻⁹ m, which is considerably smaller than the dimensions of such a plasma, generally of the order of millimeters.

### Relationship Between Micro-Hardness and Yield Stress, Tensile Strength

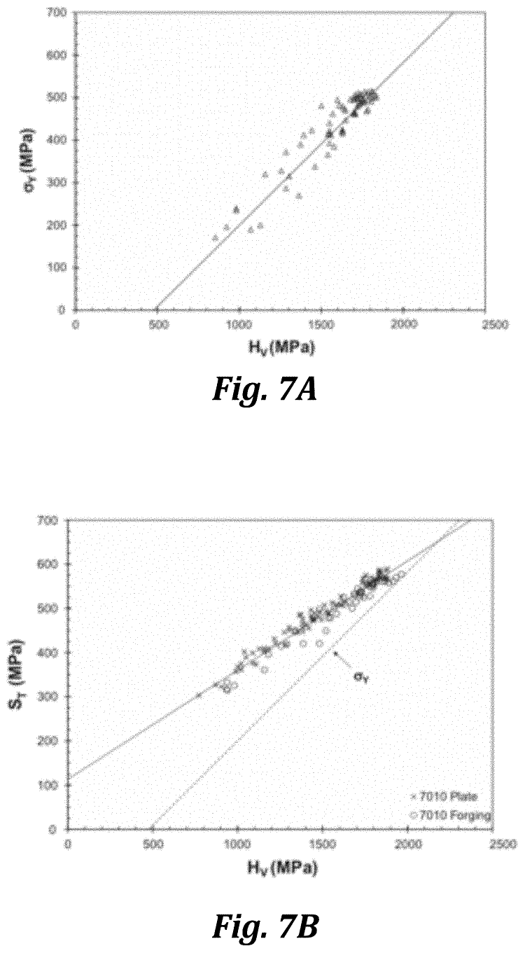

As shown in FIG. 7(a), the Vickers hardness-yield stress relationship in AA7010 has been developed from two independent datasets involving AA7010 plate and a rectilinear forging [16]:

σ_{Y}(MPa)=0.383 H_{V}−182.3

Also, an empirical relationship between tensile strength and Vickers hardness was also developed for AA7010 as shown in FIG. 7(b):

S_{T}(MPa)=0.247 H_{V}+113.1

The composition of the AA7010 plate used in above investigation is given in Table 2, below. AA7010 has a bit more Zn (˜6.26 wt %) than that (˜5.11%) of AA7075 and the empirical relation shown above may be utilized to estimate micro-hardness. Monitoring and evaluating the ratio of Mg(II)/Mg(I), micro-hardness can be predicted using the relationship developed using FIG. 7. In addition, thermal residual stress induced during the process may be estimated using aforementioned formula between micro-hardness and yielding stress and tensile strength.

TABLE 2
Chemical composition (in wt %) of AA7010

| | Si | Fe | Cu | Mg | Zn | Zr | Al |
|---|---|---|---|---|---|---|---|
| Forging | 0.03 | 0.06 | 1.69 | 2.44 | 6.26 | 0.14 | Balance |
| Plate | 0.04 | 0.05 | 1.75 | 2.34 | 6.30 | 0.12 | Balance |

### REFERENCES

1. U.S. Pat. Nos. 8,164,022; 8723,078; 9,752,988; and 9,981,341

2. Tsuyuki, K., Miura, S., Idris, N., Hendrik, K., et al., “Measurement of concrete strength using the emission intensity ratio between Ca(II) 396.8 nm and Ca(I) 422.6 nm in a Nd:YAG laser-induced plasma,” Appl. Spectroscopy, 60:61-64, 2006.

3. Cowpe, J. S., Moorehead, R. D., Moser, D., Astin, J. S., et al., “Hardness Determination of Bio-ceramics using Laser-induced Breakdown Spectroscopy,” Spectrochim. Acta B, 66:290-294, 2011.

4. Pilkington, R. D., Astina, J. S., Cowpe, J. S., “Application of Laser-induced Breakdown Spectroscopy for Surface Hardness Measurements,” Spectroscopy Europe, 27(6):13-15, 2015.

5. Vítková, G., Prokeš, L., Novotný, K., Por\check{ }ízka, P., et al., “Hardness Determination of Bio-ceramics using Laser-induced Breakdown Spectroscopy,” Spectrochim. Acta B, 101:191-199, 2014.

6. Chan, G C Y, Chan, W-T, Mao, X., and Russo, R. E., “Investigation of matrix effects in inductively coupled plasma-atomic emission spectroscopy using laser ablation and solution nebulization effect of second ionization potential,” Spectrochimica Acta Part B: Atomic Spectroscopy, 56(1):77-92, 2001.

7. Chan, G C Y. and Hieftje, G. M., “Warning indicators for the presence of plasma-related matrix effects in inductively coupled plasma-atomic emission spectrometry”, J. Anal. At. Spectrom., 23(2):181-192, 2008.

8. Le Drogoff, B., Margot, J., Chaker, M., Sabsabi, M., et al., “Temporal characterization of femtosecond laser pulses induced plasma for spectrochemical analysis of aluminum alloys” Spectrochimica Acta Part B, 56:987-1002, 2001.

9. Cottam, R., Liu, Q., Wong, Y. C., Wang, J., et al., “Laser cladding of high strength Aluminum alloy 7075 powder on a 7075 substrate for repair of damaged components”, Materials Forum Volume 35, Edited by P. Howard, P. Huggett and R. Wuhrer, Institute of Materials Engineering Australasia Ltd, pp. 89-94, 2011.

10. Durandet, Y., Brandt, M., Liu, Q., “Challenges of laser cladding Al 7075 alloy with AI-12Si Alloy powder”, Materials Forum Volume 29, Edited by P. Howard, P. Huggett and R. Wuhrer, Institute of Materials Engineering Australasia Ltd, pp. 136-142, 2011.

11. Keszler, A. M., Nemes, L. ‘Time averaged emission spectra of Nd:YAG laser induced carbon plasmas’ J. of Mole. Structure, 695:211-218, 2004.

12. Harilal S. S., Bindhu C. V., Isaac R. C., Nampoori P. N., Vallabhan C. P. G. “Electron density and temperature measurements in a laser produced carbon plasma”, Journal of Applied Physics, 82:2140-2146, 1997.

13. https://physics.nist.gov/PhysRefData/Handbook/Tables/magnesiumtable1.htm

14. Kalnicky, Dennis James, “Excitation temperature and electron number density distributions experienced by analyte species in an inductively coupled argon plasma”, Retrospective Theses and Dissertations, Iowa State University, 5752, 1976.

15. Asamoah, E., Hongbing, Y., “Influence of laser energy on the electron temperature of a laser-induced Mg plasma”, Applied Physics B, 123(1):22, 2017.

16. Tiryakioğlu, M., J. S. Robinson, M. A. Salazar-Guapuriche, Y. Y. Zhao, P. D. Eason, “Hardness-strength relationships in the aluminum alloy 7010,” Materials Science & Engineering A, 631:196-200, 2015.

17. Flynn, R. J., J. S. Robinson, J. Mater. Process. Technol., 153-154:674-680, 2004.

18. Flynn, R. J., “Property Prediction and Residual Stresses in Aluminum Alloy 7010 (Ph.D. thesis)”, University of Limerick, Ireland, 2013.

1. In an additive manufacturing process wherein a laser beam is used to heat a material to form a melt pool that solidifies to form a desired composition, and wherein a plasma is generated in a zone where the laser interacts with the material, the improvement comprising:
monitoring the plasma, in situ, using optical emission spectroscopy to generate one or more plasma spectral lines; and
analyzing the plasma spectral lines to determine a mechanical property of the composition.

2. The improvement of claim 1, wherein the mechanical property is the hardness of the composition.

3. The improvement of claim 1, wherein the mechanical property is the micro-hardness of the composition.

4. The improvement of claim 1, wherein the mechanical property is the yield stress of the material.

5. The improvement of claim 1, wherein the mechanical property is the tensile strength of the material.

6. The improvement of claim 1, wherein the composition is an alloy.

7. The improvement of claim 1, wherein the composition is an aluminum-magnesium alloy.

8. The improvement of claim 1, wherein the mechanical property is derived from a change in a ratio of the plasma spectral lines.

9. The improvement of claim 8, wherein the mechanical property is derived from a change in a ratio of ionic and neutral spectral lines.

10. The improvement of claim 9, wherein:
the composition is a 7000 series aluminum alloy; and
the mechanical property is derived from a change in a ratio of ionic and neutral magnesium (Mg).

11. The improvement of claim 10, wherein the mechanical property is the hardness of the alloy.

12. The improvement of claim 10, wherein the mechanical property is the micro-hardness of the alloy.

13. The improvement of claim 10, wherein the mechanical property is the yield stress of the alloy.

14. The improvement of claim 10, wherein the mechanical property is the tensile strength of the alloy.

15. The improvement of claim 10, wherein the mechanical property is the thermal residual stress of the alloy.

16. The improvement of claim 1, wherein the determination of the mechanical property is determined in real time.
